(19) United States
(12) Patent Application Publication
(10) Pub. No.: US 2010/0088642 A1
(43) Pub. Date: Apr. 8, 2010

(54) TELEVISION SET ENABLED PLAYER WITH A PREVIEW WINDOW

(75) Inventors: Sabrina Yeh, Laguna Beach, CA (US); Tracy Ho, San Diego, CA (US); Yuko Nishikawa, La Jolla, CA (US); Toshiyuki Suzuki, San Diego, CA (US)

Correspondence Address: SONY C/O MURABITO, HAO & BARNES LLP, TWO NORTH MARKET STREET, THIRD FLOOR, SAN JOSE, CA, 95113, US

(73) Assignees: SONY CORPORATION, Tokyo (JP); SONY ELECTRONICS, INC., Parkridge, NJ (US)

(21) Appl. No.: 12/244,315

(22) Filed: Oct. 2, 2008

(51) Int. Cl. G06F 3/048

(52) U.S. Cl. 715/835

(57) ABSTRACT

A graphical user interface (GUI) renderable on a television display. The GUI includes a plurality of selectable media categories, wherein the plurality of selectable media categories includes at least one selectable media item. The plurality of selectable media categories may include a photo media category and a music media category. The GUI further includes a workspace window comprising sections, wherein each section is associated with one of the plurality of selectable categories, and wherein the workspace window responsive to a user selecting a media item renders a graphical representation of the user selected media item in its corresponding section. Moreover, the GUI includes a preview window, wherein the preview window graphically displays a content of the user selected media item, wherein the preview occurs automatically and immediately after the user selected media item. Thus, changes as they occur can be viewed without the need to exit the edit mode.

### TECHNICAL FIELD

Embodiments of the present invention relate to the field of electronics. More particularly, embodiments of the present invention relate to a graphical user interface operable on a television set.

### BACKGROUND ART

Recently more functionality has been integrated within television sets. For example, some television sets are operable to provide Internet access and surfing capabilities in addition to television capability to show television broadcasting. Television sets may also provide various capabilities for creating and editing multimedia files, e.g., editing slideshows, editing a video clip, etc.

Unfortunately, television sets heretofore have generally poor graphical user interface (GUI) tools and are therefore not user friendly for editing or creating multimedia files. For example, while a television set may provide capabilities to create or edit a multimedia file, it is often difficult for the viewer to navigate through menus due to lacking GUI capability. As such, television sets generally do not allow much flexibility in creating or editing multimedia files.

Moreover, television sets currently do not facilitate a preview of the content as the multimedia file is being edited or created. In other words, a user cannot view the changes as they occur without manually exiting the edit mode. Requiring users to exit the edit mode in order to view their changes is not only time consuming and laborious but it is also inconvenient. It is especially inconvenient for a user to exit the edit mode each time that the user wishes to make a change and view the change, in particular when there are many incremental changes to be made.

### SUMMARY

Accordingly, a need has arisen to provide an improved graphical user interface (GUI) operable for a television set; the GUI being user friendly and well suited for editing and creating multimedia files. More specifically, a need has arisen to provide a GUI for a television set to enable a user to visually create and edit multimedia files in a non-personal computer (PC) like fashion. Moreover, it is advantageous to provide a preview window in edit mode such that changes to the multimedia files can be previewed simultaneously as the changes occur. Thus, a user can view the changes in a preview window as they occur without the need to exit the edit mode. It will become apparent to those skilled in the art in view of the detailed description of the present invention that the embodiments of the present invention remedy the above mentioned needs and provide the above referenced advantages.

In one embodiment of the present invention, a non-PC like GUI for creating and editing a multimedia file is provided for operation on a television set. The GUI according to one embodiment comprises a plurality of selectable media categories, e.g., a photo album, a music album, a text category, an animation category, etc. At least one of the selectable media categories contains a selectable media item, e.g., a music file, a picture, a word document, etc. It is appreciated that at least one selectable non-media category may be also provided. For example, a setting category for adjusting the setting and adjusting the display effect of a multimedia file may be provided.

The GUI may further include a workspace on-screen display window that is divided into sections where each section corresponds to a selectable category, e.g., audio category, visual category, setting category, etc. A graphical representation of a selectable media item may be displayed in its corresponding section in the workspace window when a user selects the selectable media item. As soon as the user makes the selection of the selectable media item, the content is previewed in a preview window of the GUI. As a result, changes to a multimedia file can be previewed simultaneously as they occur, thereby eliminating the need to exit the edit mode in order to view the changes to the content of the multimedia file.

More specifically, an embodiment of the present invention pertains to a GUI rendered on a television display. The GUI includes a plurality of selectable media categories, wherein the plurality of selectable media categories includes at least one selectable media item. The plurality of selectable media categories may include a photo media category and a music media category.

The GUI further includes a workspace on-screen display window comprising sections, wherein at least one of the sections is associated with at least one of the plurality of selectable media categories, and wherein the workspace window responsive to a user selecting a media item renders a graphical representation of the user selected media item in its corresponding section. Moreover, the GUI includes a preview window, wherein the preview window graphically displays a content of the user selected media item while the workspace window renders the graphical representation of the user selected media item, wherein the preview occurs automatically and immediately after the user selected media item.

According to one embodiment, the GUI may further include expanded media items associated with a selectable media category, wherein the expanded media items are user selectable, and wherein the expanded media items are displayed responsive to a user selecting the selectable media category. In one embodiment, the expanded media items are graphically collapsed responsive to a user selection.

It is appreciated that the GUI may further include additional functionalities. For example, the GUI may include a transport control operable to control display of the content of the user selected media item in the preview window. In one exemplary embodiment, the transport control is selected from a group consisting play, pause, stop, rewind and fast forward operations. In one embodiment, the GUI includes a selectable effect category including at least one selectable effect item operable to configure transition and representation of the content of the user selected media item in said preview window.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 shows an exemplary system in accordance with one embodiment of the present invention.

FIGS. 2A, 2B, 2C, 2D, 2E and 2F show exemplary operations of a GUI responsive to a user selection in accordance with one embodiment of the present invention.

FIGS. 3A and 3B show an exemplary GUI with a transport functionality in accordance with one embodiment of the present invention.

FIG. 4 shows an exemplary flow diagram for rendering a GUI on a television display in accordance with one embodiment of the present invention.

FIG. 5 illustrates an exemplary television set that may serve as a platform for embodiments of the present invention.

### DETAILED DESCRIPTION

Reference will now be made in detail to embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details. In other instances, well known methods, procedures, components, and circuits have not been described in detail as not to unnecessarily obscure aspects of the invention.

### Notation and Nomenclature

Some portions of the detailed descriptions which follow are presented in terms of procedures, steps, logic blocks, processing, and other symbolic representations of operations on data bits that can be performed on television set memory. These descriptions and representations are the means used by those skilled in the art to most effectively convey the substance of their work to others skilled in the art. A procedure, television set executed step, logic block, process, etc., is here, and generally, conceived to be a self-consistent sequence of steps or instructions leading to a desired result. The steps are those requiring physical manipulations of physical quantities.

Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “creating” or “transferring” or “executing” or “determining” or “instructing” or “issuing” or “halting” or “clearing” or “accessing” or “aggregating” or “obtaining” or “selecting” or “calculating” or “measuring” or “querying” or “receiving” or “sending” or “providing” or “storing” or “displaying” or “rendering” or “expanding” or “collapsing” or the like, refer to the action and processes of a television set, or similar electronic computing device, that manipulates and transforms data represented as physical (electronic) quantities within the television set's registers and memories into other data similarly represented as physical quantities within the television set memories or registers or other such information storage, transmission or display devices.

A Television Set Enabled Player with a Preview Window

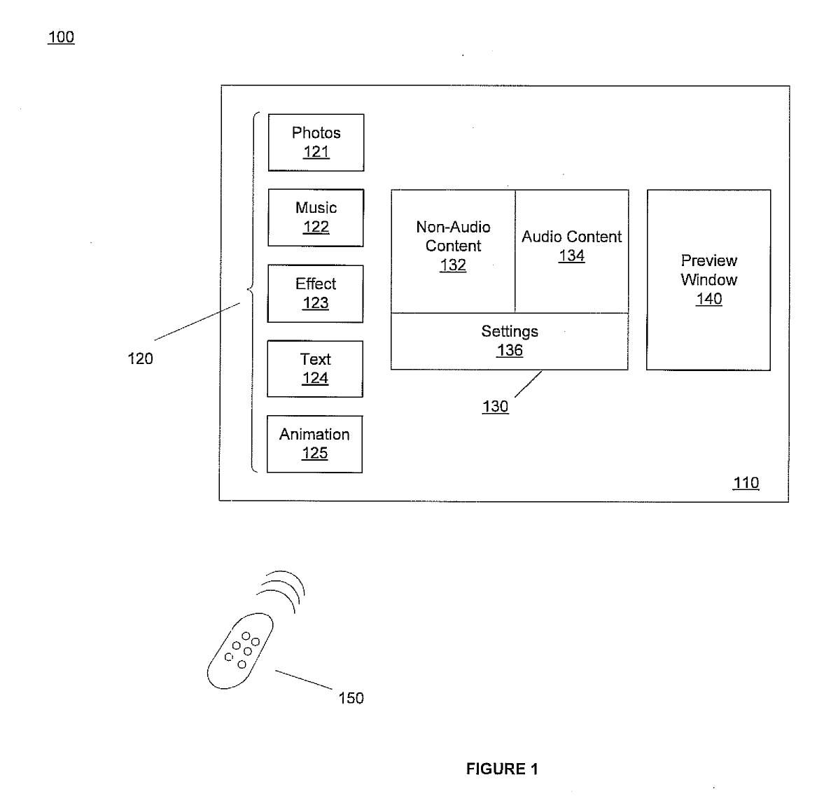

Referring now to FIG. 1, an exemplary system 100 in accordance with one embodiment of the present invention is shown. The system 100 includes a graphical user interface (GUI) 110 that is renderable on a television set and a remote control 150 for controlling the operation of the GUI 110 and the television set. The GUI 110 may be used to edit and/or create a multimedia file, e.g., slideshow. Throughout the detailed description editing a slide show is given as an example, however, embodiments of the present invention should not be construed limited thereto. For example, a multimedia file may include editing a video clip, etc. As such, a slideshow is merely given as an example and is not intended to limit the scope of the present invention.

The GUI 110 includes a plurality of selectable categories 120. The GUI 110 may further include an on-screen workspace window 130 and an on-screen preview window 140. The remote control 150 may be used to navigate through a menu and to make a selection of various selectable categories 120 and the items therein. For example, the user may use the arrow buttons on the remote control 150 to navigate through the selectable items, categories, etc., in order to select the desired item and/or category. It is appreciated that the remote control 150 may be infrared (IR) and/or radio frequency (RF) enabled, etc. A graphical representation of the selected media items may be displayed on-screen in the workspace window 130 while their corresponding content are automatically being rendered in the preview window 140. Thus, a user may view the changes in the preview window 140 as they occur without a need to exit the edit mode.

The plurality of selectable categories 120 may include multimedia categories such as photos 121, music 122, text 124 and animation 125. The photos 121 category may include various photo albums and pictures. The music 122 category may include various tunes and music including albums and songs. The text 124 category may include textual based information. The animation 125 category may include various animations. It is appreciated that each selectable category may further include additional selectable categories. For example, the music 122 category may contain various selectable albums, e.g., Beatles, 50 Cent, etc., where each album contains various songs and music.

The plurality of selectable categories 120 may also include at least one non-multimedia category such as effect category 123. The effect 123 category may configure the transition and representation of the content of the multimedia file. The effect 123 category may include wipe, collage, fade, maze and the speed by which content is being transitioned, e.g., the transition speed from one slide to the next.

In one embodiment, the workspace window 130 may be divided into a plurality of on-screen regions or sections, e.g., non-audio content 132, audio content 134 and settings 136. It is appreciated that the GUI may contain any number of sections even though only three sections are shown. As such, three sections within the workspace window 130 are merely exemplary and this illustration is not intended to limit the scope of the present invention.

Each section may correspond to at least one selectable category that may be a multimedia category or non-multimedia category. For example, media items from the selectable multimedia categories, e.g., photos 121, text 124 and animation 125, may correspond to the non-audio content 132 section. As such, graphical representations of non-audio multimedia items, e.g., photo, animation, etc., are displayed in the non-audio content 132 section when a user selects a multimedia item from the photo 121, text 124 and/or the animation 125 category.

Similarly, the audio content 134 section may correspond to the music 122 category. Thus, items selected from the music 122 category may be graphically represented in the audio content 134 section. According to one embodiment, the settings 136 section may correspond to the effect 123 category. Thus, the effect items selected from the effect 123 category may be graphically rendered in the settings 136 section.

It is appreciated that when an item, e.g., a media item, is selected by a user via the remote control 150, the graphical representation of the selected media item is displayed in its corresponding section of the workspace window 130. In conjunction with displaying the graphical representation of the selected media item in the workspace window 130, the content of the selected media item is rendered in the preview window 140. For example, if the selected media item is a music file, the graphical representation of the music file is displayed in the audio content 134 section while the content, e.g., the music file itself, is automatically rendered in the preview window 140, which plays the selected music file. Similarly, if the media item is a photograph, the graphical representation of the photograph is displayed in the non-audio content 132 section of the workspace 130 window while the content, e.g., the photograph itself, is automatically rendered in the preview window 140.

As a result, the user may preview the changes to the multimedia file as they occur, thereby eliminating the need to exit the edit mode to view the changes. Moreover, the GUI 110 is user friendly and intuitive since the selected items, e.g., media items, and the selectable categories are graphically represented in their corresponding sections and their content is previewed in the preview window.

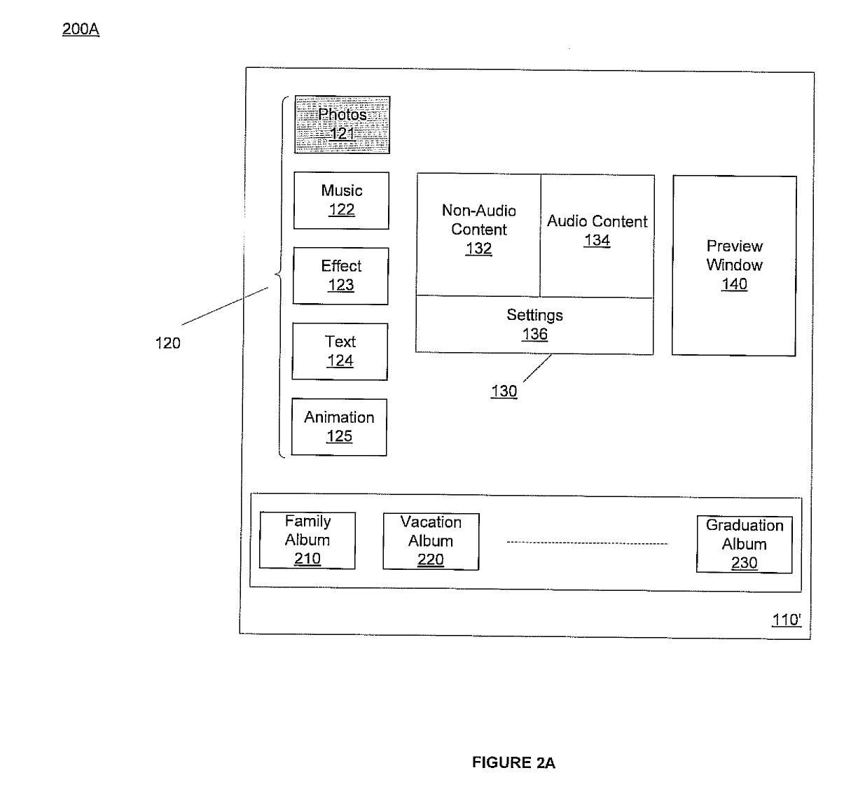

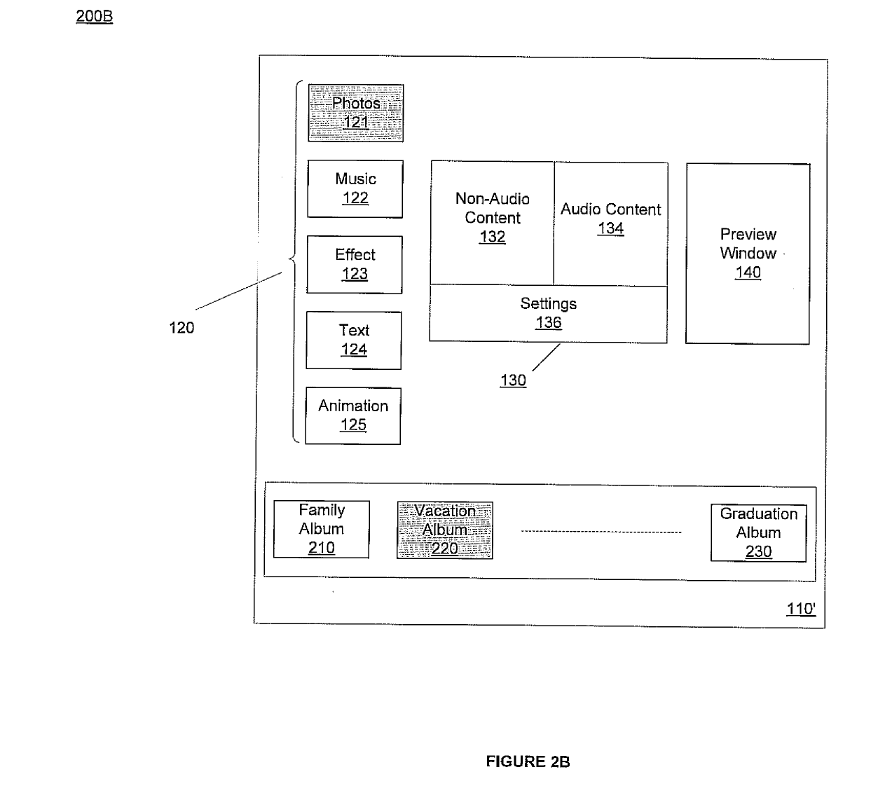

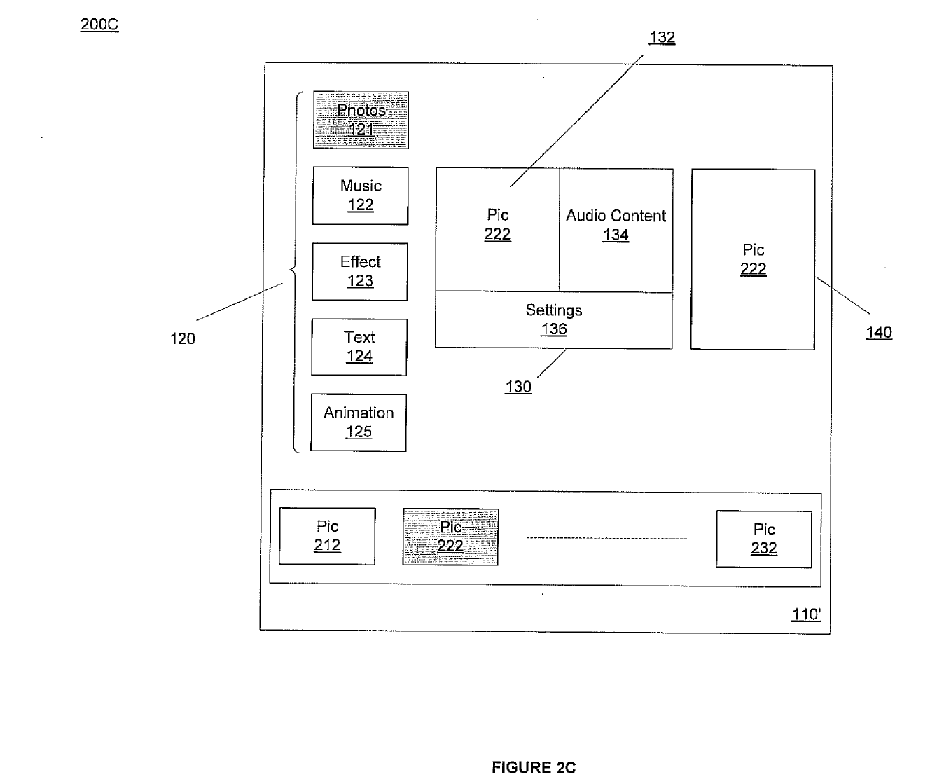

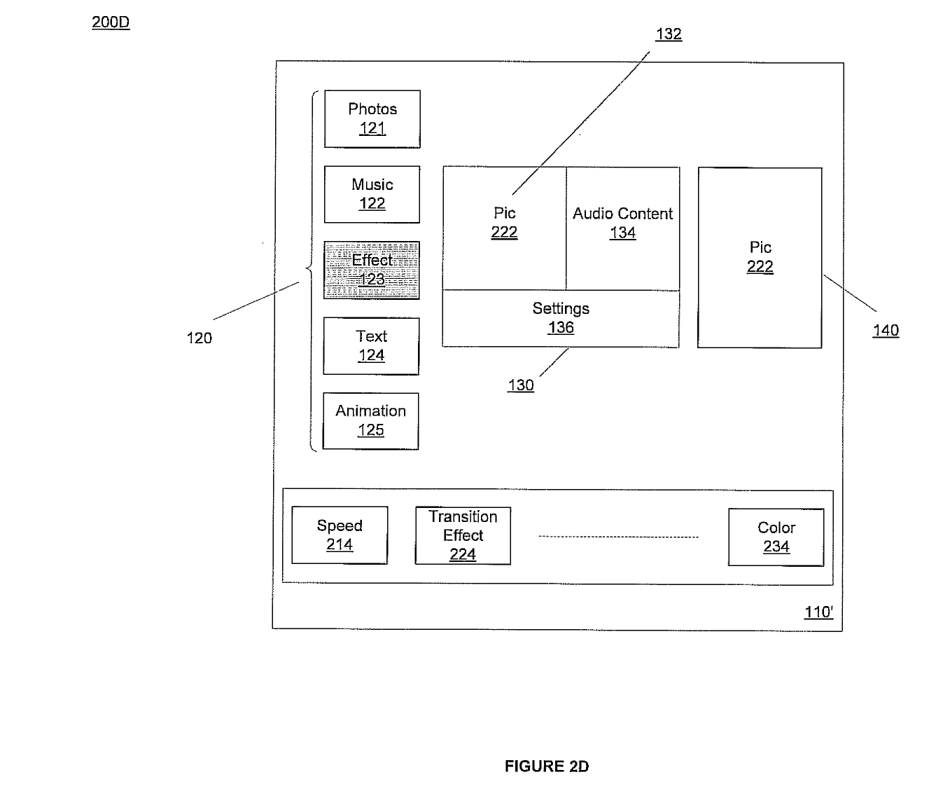

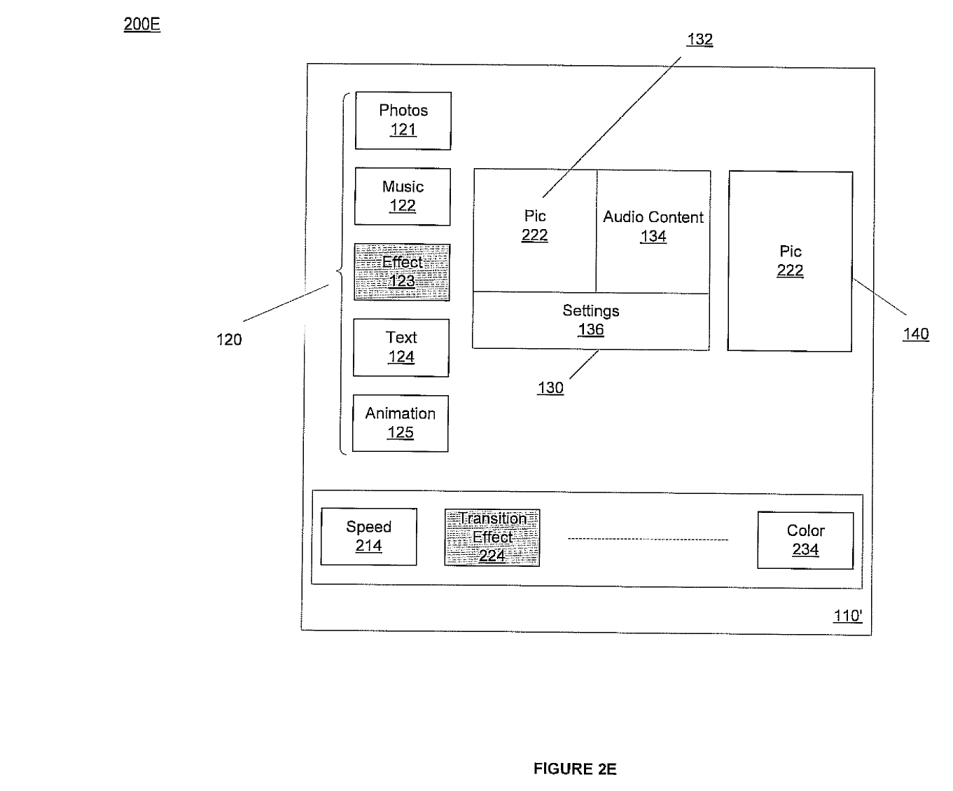

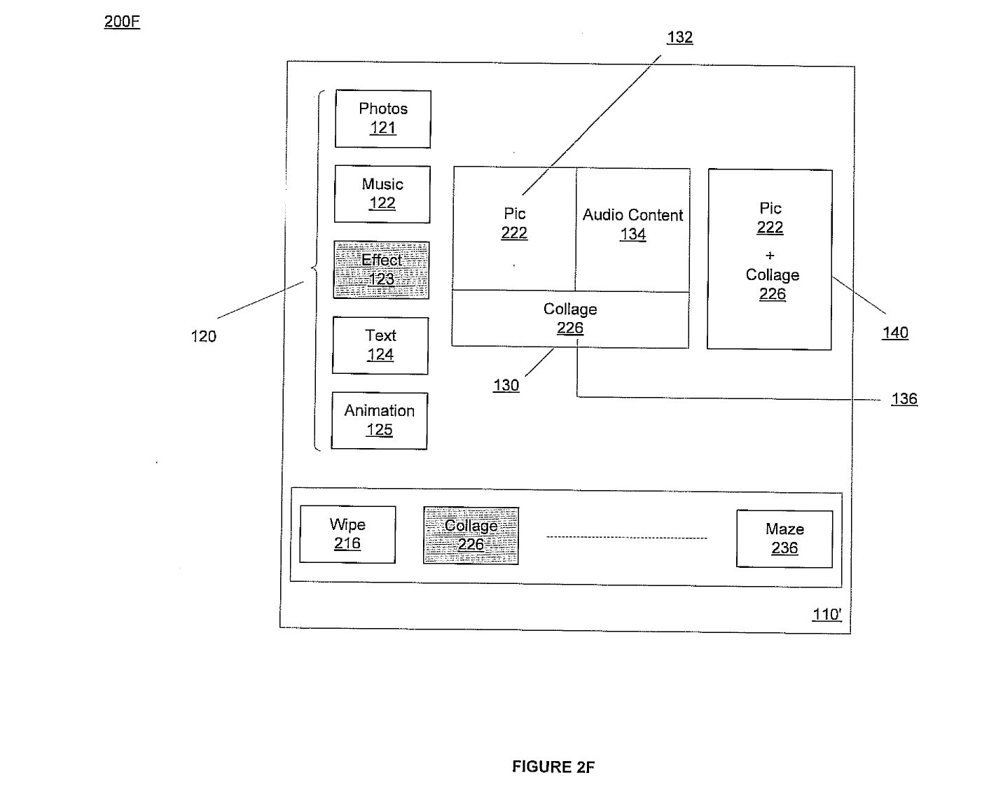

Referring now to FIGS. 2A-2F, exemplary operations of a graphical user interface (GUI) responsive to user selections in accordance with one embodiment of the present invention are shown. Referring to FIG. 2A, the GUI 110′ similar to the GUI 110 of FIG. 1 is shown. A user may utilize the remote control 150 to navigate through a menu and make a selection from the plurality of selectable categories 120. For example, the user may select the selectable on-screen photo 121 category. A plurality of selectable categories that are within the photo 121 category may now be displayed, e.g., family album 210, vacation album 220, graduation album 230, etc., when the photo category 121 is selected. In other words, the selection of a selectable category, e.g., photo 121, may graphically expand selectable items within that category, e.g., photo 121. It is appreciated that the user may wish to graphically collapse the expanded category. As such, the user may select another selectable category, e.g., music 122 category, to automatically collapse the previously selected category while graphically expanding the newly selected category. In one embodiment, the user may select a graphical object on the GUI 110 (not shown) that corresponds to expand/collapse functionality of selectable categories. Accordingly, the expanded category may be graphically collapsed without selecting another category.

Referring now to FIG. 2B, the user may select an appropriate multimedia selectable category from the display, e.g., vacation album 220. Selecting the vacation album 220 category may graphically expand and display multimedia items such as pictures from vacation album 220 category. For example, selecting the vacation album 220 may display pic 212, pic 222, pic 232, etc., as shown in FIG. 2C. In other words, selecting the vacation album 220 category graphically expands multimedia items within the vacation album 220 category.

The user may select multimedia items from the graphically expanded multimedia items. For example, the user may select pic 222 multimedia item. Selecting a multimedia item causes the graphical representation of the selected item to be displayed in the appropriate section within the workspace window 130. For example, selection of the pic 222, if a non-audio content, may cause the graphical representation of pic 222 to be displayed in the non-audio content 132 section of the work space 130, as shown in FIG. 2C. It is appreciated that when the multimedia item, e.g., pic 222, is selected, the content of the selected multimedia item is rendered on the display in the preview window 140, as shown in FIG. 2C. Accordingly, once a multimedia item is selected, the content of the multimedia item is rendered such that the content is previewed without a need to exit the edit mode. In other words, the changes and edits can be viewed simultaneously as they occur by rendering the content of the recently selected item in the preview window 140.

It is appreciated that additional multimedia items may be selected in a similar manner. For example, a music item, e.g., a song, within the music 122 category may be similarly selected. The selection of the music item causes the graphical representation of the music item to be displayed in the audio content 134 section of the workspace window 130. The rendition of the graphical representation of the music item in the audio content 134 section of the workspace 130 occurs at the same time that the content of the music item is rendered in the preview window 140. For example, when the audio item is selected after the selection of the pic 222, the audio content of the music item may be rendered via speakers as the content of pic 222 is being rendered in the preview window 140.

Referring now to FIG. 2D, a selection of a non-multimedia selectable category, e.g., effect 123 category, is shown. When the user selects the effect 123 category utilizing the remote control 150, the content within the effect 123 category may be graphically expanded. For example, the effect category 123 may comprise various items such as speed 214, transition effect 224 and color 234, to name a few. The speed 214 may indicate the speed by which the selected contents are transitioned, e.g., transition speed from one slide to another. The transition effect 224 may be the manner by which the content transitions, e.g., wipe, collage, maze, etc. The color 234 may be the background color for the multimedia file.

It is appreciated that the items within the effect 123 category are exemplary and should not be construed as limiting the scope of the present invention but are merely given as examples of various embodiments. It is further appreciated that the graphically expanded effect 123 category may be graphically collapsed in a fashion similar to that described above.

FIG. 2E shows the user selecting the transition effect 224 category that is one of the graphically expanded categories within the effect 123 category. FIG. 2F shows the on-screen graphically expanded items within the transition effect 224 category. For example, the transition effect 224 category may include a wipe 216, a collage 226 and a maze 236 item, etc. It is appreciated that the category may include additional items and that the items described herein are exemplary and not intended to limit the scope of the present invention.

The user may select the collage 226 item within the effect 123 category. As a result, a graphical representation of the collage 226 item is displayed within the settings 136 section of the workspace window 130. Simultaneously, the collage 226 effect is applied to the content of the selected content, pic 222. Thus, the content of pic 222 is rendered with the collage 226 effect in the preview window 140 as the selection occurs and without a need to exit the edit mode.

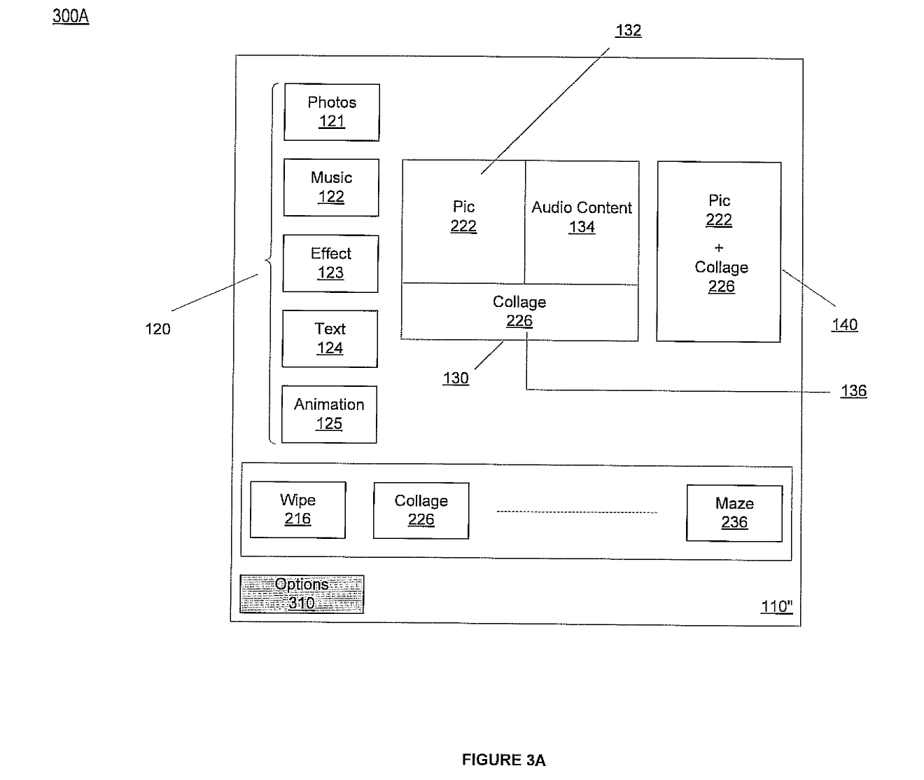

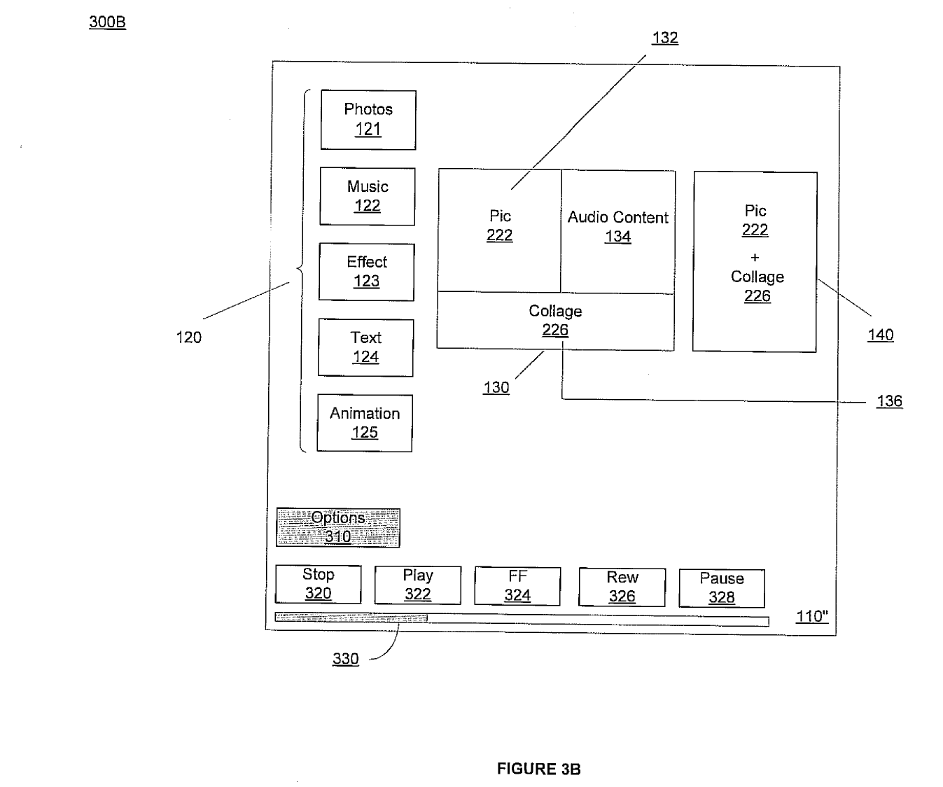

Referring now to FIGS. 3A and 3B, an exemplary on-screen GUI 110″ with a transport functionality in accordance with one embodiment of the present invention is shown. The transport functionality may enable the user to control the rendition of the selected content in the on-screen preview window 140. For example, the transport functionality may enable the user to preview the selected content at normal speed, at slow motion, pause, stop, fast forward, rewind and etc. According to one embodiment, the transport functionality is provided via a graphical icon rendered on the display. For example, options 310 button may provide additional options including the transport functionality. FIG. 3A shows the user selection of the options 310 button.

Selection of the options 310 may provide additional functionality for the transport functionality as shown in FIG. 3B. For example, selecting the options 310 button may provide additional graphical icons representing stop 320, play 322, fast forward 324, rewind 326 and pause 328 functionalities for controlling the content rendered in the preview window 140. As such, the preview of the content in the preview window 140 may be controlled by stopping, pausing, fast forwarding, rewinding and playing the content as desired. According to one embodiment, a bar 330 may display the current location of the content rendered with respect to the entire selected content in the preview window 140.

It is appreciated that in one embodiment, the placement of the content rendered in the preview window 140 may be controlled by dragging the highlighted portion of the bar 330 back and forth. It is further appreciated that the transport functionality may also be provided via the remote control 150. For example, the play, stop, rewind, fast forward and the pause buttons on the remote control 150 may be used alternatively or in conjunction with the plurality of buttons 310, 320, 322, 324, 326, 328 and 330. It is appreciated that the transport functionalities described are exemplary and should not be construed as limiting the scope of the present invention.

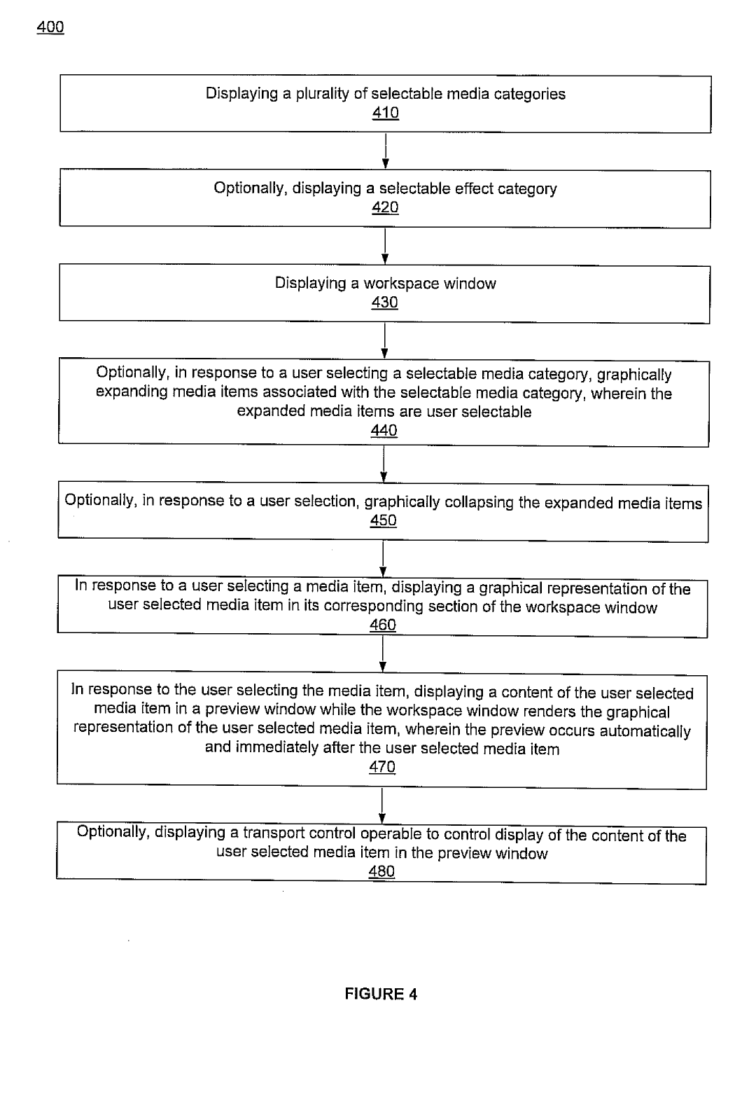

Referring now to FIG. 4, an exemplary computer implemented flow 400 diagram for rendering a GUI on a television display in accordance with one embodiment of the present invention is shown. At step 410, a plurality of selectable media categories is displayed on the television set. In one embodiment, selectable media categories may include the photo 121, the music 122 and the animation 125 categories, to name a few. Optionally, at step 420, a selectable non-media category may be displayed. For example, the selectable non-media category may include the effect 123 category. It is appreciated that more than one selectable non-media category may be displayed. As such, displaying the effect 123 category is exemplary and is not intended to limit the scope of the present invention.

At step 430, a workspace window is displayed. For example, the workspace window 130 may be displayed on a liquid crystal display (LCD) or any other suitable display technology. According to one embodiment, the workspace window 130 includes multiple sections wherein each section is associated with at least one of the selectable categories, e.g., the photo 121 category. In one embodiment, the workspace window 130 includes three on-screen sections, the non-audio content 132, the audio content 134 and the settings 136 section. However, it is appreciated that any number of sections may be included and the three sections described above are exemplary and not intended to limit the scope of the present invention.

Optionally, at step 440, in response to a user selecting one of the selectable media categories, items associated with the selected category are graphically expanded. In other words, items within the selectable category are displayed for user selection. It is appreciated that graphically expanding the items within a selectable media category may be by selecting another selectable media category and/or by selecting a graphical icon on the GUI 110 that indicates expansion of the items. It is appreciated that step 440 is equally applicable to non-media categories, e.g., effect category, and the items therein.

Optionally, at step 450, the expanded items may be graphically collapsed responsive to a user selection. In one exemplary embodiment, the expanded items are graphically collapsed when the user selects a different selectable category. According to one embodiment, the collapse of the expanded items may be via a graphical icon on the GUI that indicates that the selection of the icon collapses the expanded items.

At step 460 of FIG. 4, in response to a user selecting a media item, e.g., the pic 220, a graphical representation of the selected media item is displayed in its appropriate section of the workspace window 130. For example, the selected media item, e.g., pic 222, is graphically represented in the non-audio content 132 section of the workspace window 130. At step 470, responsive to the user selecting the media item, the content of the user selected media item is displayed and rendered in the preview window 140. For example, the content of the selected media item, e.g., pic 222, is rendered in the preview window 140 while the workspace window 130 renders the graphical representation of the user selected media item, e.g., pic 222. It is appreciated that the preview occurs automatically and immediately after the user selects the media item, e.g., pic 222. As a result, the changes and edition to a multimedia file can be viewed in the preview window 140 as they occur without a need to exit the edit mode. Thus, editing and changing multimedia items become less tedious and more user friendly by eliminating the requirement of the user to exit the edit mode in order to view changes.

Optionally, at step 480, a transport control may be displayed in order to control the rendition of the content of the user selected media items in the preview window 140. For example, the transport control may include graphical icons representing play, stop, pause, fast forward, rewind and etc., that controls the rendition of the content in the preview window 140. It is appreciated that the transport control may be via the play, stop, pause, fast forward and rewind buttons that are located on the remote control 150.

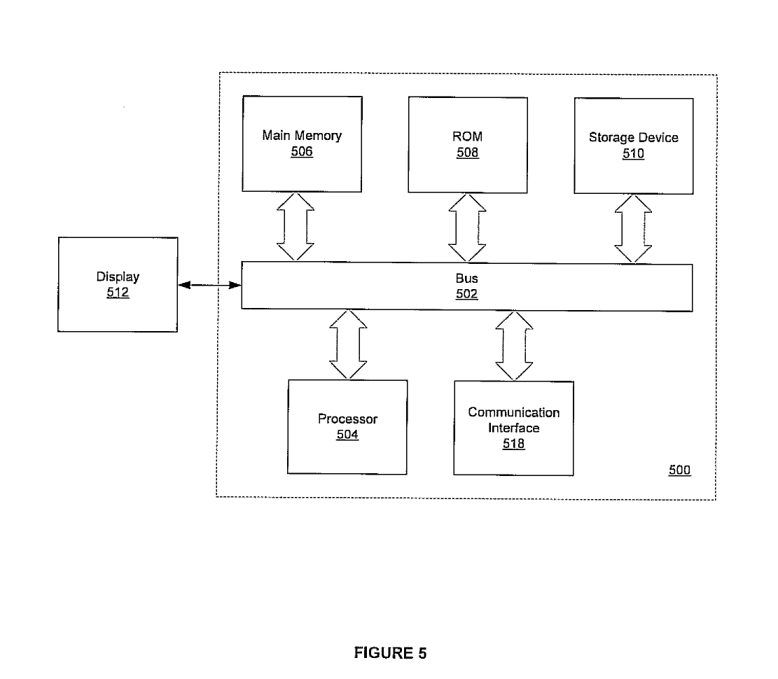

FIG. 5 illustrates an exemplary computer controlled television set 500 that may serve as a platform for embodiments of the present invention. The exemplary television set 500 may implement the process for rendering a GUI on the television set display as shown in FIGS. 1-4 and includes a bus 502 or other communication mechanism for communicating information, and a processor 504 coupled with bus 502 for processing information.

The exemplary television set 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. The exemplary television set 500 further includes a read only memory (ROM) 508 or other static storage device coupled to bus 502 for storing static information and instructions for processor 504. A non-volatile storage device 510, such as a magnetic disk or optical disk, is provided and coupled to bus 502 for storing information and instructions and may store the persistent internal queue. According to one embodiment, the instructions for implementing the virtual device may be stored on any one of the memory components (e.g., RAM, ROM, non-volatile storage device and etc.). The exemplary television set 500 may be coupled via bus 502 to a display 512, such as a cathode ray tube (CRT), for displaying information to a computer user.

The term “computer-readable medium” as used herein refers to any medium that participates in providing instructions to processor 504 for execution. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer or a television set can read.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A graphical user interface (GUI) operable to be rendered on a television display comprising:
a plurality of on-screen selectable media categories, wherein said plurality of selectable media categories comprises at least one selectable media item;
an on-screen workspace window comprising sections, wherein at least one of said sections is associated with at least one of said plurality of selectable media categories, and wherein said workspace window, responsive to a user selecting a media item, renders a graphical representation of said user selected media item in its corresponding section; and
an on-screen preview window for graphically displaying a content of said user selected media item while said workspace window renders said graphical representation of said user selected media item, wherein said preview occurs automatically and after said user selected media item.

2. The GUI as described in claim 1 further comprising:
additional on-screen media items associated with a selectable media category, wherein said additional on-screen media items are user selectable, and wherein said additional on-screen media items are displayed responsive to a user selecting said selectable media category.

3. The GUI as described in claim 2 further comprising:
in response to a user selection, graphically collapsing said additional on-screen media items.

4. The GUI as described in claim 1 further comprising:
a transport control operable to control display of said content of said user selected media item in said preview window.

5. The GUI as described in claim 4, wherein said transport control is selected from a group consisting of the following operations: play; pause; stop; rewind; and fast forward.

6. The GUI as described in claim 1, wherein said plurality of selectable media categories comprises: a photo media category and a music media category.

7. The GUI as described in claim 1 further comprising:
an on-screen selectable effect category comprising at least one selectable effect item operable to configure transition and representation of said content of said user selected media item in said preview window.

8. A system comprising:
a remote control operable to control an operation of a television set; and
said television set comprising a memory for storing instructions and data thereon and a processor operable to execute said instructions stored thereon to implement a graphical user interface (GUI), said GUI comprising:
a plurality of on-screen selectable media categories, wherein said plurality of selectable media categories comprises at least one selectable media item;
an on-screen workspace window comprising sections, wherein at least one of said sections is associated with at least one of said plurality of selectable media categories, and wherein said workspace window, responsive to a user selecting a media item, renders a graphical representation of said user selected media item in its corresponding section; and
an on-screen preview window for graphically displaying a content of said user selected media item while said workspace window renders said graphical representation of said user selected media item, wherein said preview occurs automatically and after said user selected media item.

9. The system as described in claim 8 wherein said GUI further comprises:
additional on-screen media items associated with a selectable media category, wherein said additional on-screen media items are user selectable, and wherein said additional on-screen media items are displayed responsive to a user selecting said selectable media category.

10. The system as described in claim 9 wherein said GUI further comprises:
in response to a user selection via said remote control, graphically collapsing said additional on-screen media items.

11. The system as described in claim 8 wherein said GUI further comprises:
a transport control operable to control display of said content of said user selected media item via said remote control in said preview window.

12. The system as described in claim 11, wherein said transport control is selected from a group consisting of the following operations: play; pause; stop; rewind; and fast forward.

13. The system as described in claim 8, wherein said plurality of selectable media categories comprises: a photo media category and a music media category.

14. The system as described in claim 8 wherein said GUI further comprises:
an on-screen selectable effect category comprising at least one selectable effect item operable to configure transition and representation of said content of said user selected media item in said preview window, wherein said selectable effect category is selectable via said remote control.

15. A computer readable medium comprising instructions that when executed implement a method for rendering a graphical user interface (GUI) on a television display, said method comprising:
displaying a plurality of selectable media categories, wherein said plurality of selectable media categories comprises at least one selectable media item;
displaying a workspace window comprising sections, wherein at least one of said sections is associated with at least one of said plurality of selectable media categories;
in response to a user selecting a media item, displaying a graphical representation of said user selected media item in its corresponding section of said workspace window; and
in response to said user selecting said media item, displaying a content of said user selected media item in a preview window while said workspace window renders said graphical representation of said user selected media item, wherein said preview occurs automatically and after said user selected media item.

16. The computer readable medium as described in claim 15 wherein said method further comprises:
in response to a user selecting a selectable media category, graphically expanding media items associated with said selectable media category, wherein said expanded media items are user selectable.

17. The computer readable medium as described in claim 16 wherein said method further comprises:
in response to a user selection, graphically collapsing said expanded media items.

18. The computer readable medium as described in claim 15 wherein said method further comprises:
displaying a transport control operable to control display of said content of said user selected media item in said preview window.

19. The computer readable medium as described in claim 18, wherein said transport control is selected from a group consisting of the following operations: play; pause; stop; rewind; and fast forward.

20. The computer readable medium as described in claim 15, wherein said plurality of media categories comprises: a photo media category and a music media category.

21. The computer readable medium as described in claim 15 wherein said method further comprises:
displaying a selectable effect category comprising at least one selectable effect item operable to configure transition and representation of said content of said user selected media item in said preview window.
